(19) United States
(12) Patent Application Publication
(10) Pub. No.: US 2015/0240400 A1
(43) Pub. Date: Aug. 27, 2015

(54) ALIGNMENT TOOL

(71) Applicant: Marcia L. Baker, Fort Collins, CO (US)

(72) Inventor: Marcia L. Baker, Fort Collins, CO (US)

(21) Appl. No.: 14/630,395

(22) Filed: Feb. 24, 2015

Related U.S. Application Data
(60) Provisional application No. 61/945,638, filed on Feb. 27, 2014.

(51) Int. Cl. D05B 97/12; G01B 3/14

(52) U.S. Cl. CPC D05B 97/12; G01B 3/14

(57) ABSTRACT

A tool and system for use in the sewing and quilting of material are provided, the system includes a transparent measuring device having a plurality of lines a repositionable tool that facilitates repeated alignment with a desired location, line, or point on the transparent ruler to aid in aligning the ruler with underlying material for accurate cutting and sewing or quilting of the material. The tool includes a body, a window formed in the body that provides a view through the body to the tool and through the tool to the underlying material, and at least one physical feature formed in the body that is configured to facilitate longitudinal orientation of the body with a first line on the transparent measuring device and transverse orientation of the tool with a second line on the transparent measuring device. The physical feature can include at least one or more of a vertex or cut-out in the perimeter of the body to aid in visually aligning the body with indicia on the ruler.

### BACKGROUND

1. Technical Field

The present disclosure pertains to aids for measuring, cutting, and assembling material in the sewing and quilting crafts and, more particularly, to a repositionable tool that facilitates repeated alignment with a desired location, line, or point on a transparent ruler to aid in aligning the ruler with underlying material for accurate cutting and sewing or quilting of the material.

2. Description of the Related Art

In quilting, when cutting fabric or pieced blocks with a rotary cutter, there is a substantial amount of repetitive aligning of a transparent ruler with underlying fabric material. The more popular rulers have many lines on them to accommodate different sizes of projects. When aligning the ruler with the material, it takes time and memory to position the correct line or other alignment point on the ruler over the intended portion of the underlying material or fabric.

The real frustration comes when the wrong line or alignment point on the ruler is positioned over the material and the material is then cut. This can result in permanently ruining the fabric or pieced block of material. To avoid this error, some quilters mark their ruler with an ink marker. This is not a lasting solution because the mark may rub off with use or the mark may not come off when the project is done, permanently defacing the ruler and interfering with its future use. Other quilters position masking tape at the alignment point. However, regular masking tape leaves a residue on the ruler that when cleaned with the wrong product can permanently damage the ruler. Painter's masking tape works better as far as removal, but it requires careful cutting or tearing of the tape with each use. Also, tacky note paper can be used. However, none of these proposed solutions provide a lasting reusable solution, and they do not give detail to the alignment point. They also can obscure the information around the alignment point.

One product specific to the industry, Glo-line™ tape, is used to highlight a particular line on the ruler but not necessarily a specific point. Others have used repositionable reinforcement rings and marked cross hair lines on them. Because the paper obscures the fabric around it, it must be marked by hand with lines corresponding to the axes. For example, FIG. 1 shows such a device 7 applied to an existing ruler 8. The device 7 has a ring shape with hand-drawn radial lines 9 positioned 90 degrees around the ring for positioning next to an existing line on the ruler 8, as shown. This proposed solution does not provide for accurate line drawing or location of the lines 9 around the ring. It is also difficult to see the underlying ruler lines because of the opaque ring.

### BRIEF SUMMARY

The present disclosure provides a repositionable alignment tool that enables the user to align a line or other alignment point on a ruler with underlying material without requiring memorization of the ruler line number or searching for the location of the line or alignment point on the ruler.

In accordance with one aspect of the present disclosure a tool for use in aligning a transparent measuring device having a plurality of lines with underlying material is provided. The tool includes a body, a window formed in the body that provides a view through the body to the transparent measuring device and through the transparent measuring device to the underlying material, and at least one physical feature formed in the body that is configured to facilitate longitudinal orientation of the body with a first line on the transparent measuring device and transverse orientation of the tool with a second line on the transparent measuring device.

In accordance with another aspect of the present disclosure, the body comprises flexible material having static cling properties for removably adhering the body to the transparent measuring device.

In accordance with a further aspect of the present disclosure, the window is one of either a transparent portion of the body or an opening formed through the body that is sized and shaped to provide a line of sight through the body to the tool and through the tool to the underlying material.

In accordance with yet another aspect of the present disclosure, the physical feature includes at least one from among a vertex or a cutout in a perimeter of the body.

In accordance with still yet a further aspect of the present disclosure, the body has a planform shape of a diamond with a longitudinal axis and a transverse axis, the longitudinal axis bisecting opposing first and second vertices and the transverse axis bisecting opposing third and fourth vertices. Preferably, each of the first and second vertices has an interior angle of 60 degrees and each of the third and fourth vertices has an interior angle of 120 degrees.

In accordance with another aspect of the foregoing tool described above, the window has a circular shape with a center point positioned to coincide with the intersection of the longitudinal and transverse axes of the diamond-shaped body.

In accordance with a further aspect of the present disclosure, a system for use in the sewing and quilting of material is provided. The system includes a transparent measuring device having a plurality of lines; and a tool for use in aligning the transparent measuring device with the material. The tool includes a body, a window formed in the body that provides a view through the body to the transparent measuring device and through the transparent measuring device to the underlying material, and at least one physical feature formed in the body that is configured to facilitate longitudinal orientation of the body with a first line on the transparent measuring device and transverse orientation of the tool with a second line on the transparent measuring device.

As will be readily appreciated from the foregoing, the tool of the present disclosure will facilitate the user identifying a line or other ruler alignment point for a particular measurement or location on the ruler and easily see that the ruler is aligned correctly with the underlying material. In the diamond shaped configuration, the longer end is used as this type of pointer. The center circle and the four corners of the diamond create a site with cross-hairs to center a particular point on the ruler with a particular point on the fabric or pieced block. By having the sighting window, the user can see that the point is aligned. By having the four corners and the elongated diamond, if needed, a longitudinal and lateral or transverse orientation of the tool can be made on the ruler and similarly an orientation of the ruler can be made relative to the underlying material. The device is easily applied to the ruler, can be easily repositioned, does not leave residue, is transparent or translucent to not obscure the surrounding area, and gives three different methods to visualizing or locating and identifying a line or other alignment point on the ruler. It solves the problem without creating other problems.

### BRIEF DESCRIPTION OF THE SEVERAL VIEWS OF THE DRAWINGS

The foregoing features and advantages of the present disclosure will be more readily appreciated as the same become better understood from the accompanying drawings, wherein:

FIG. 1 illustrates a known alignment device on a transparent ruler;

FIG. 2 is an illustration of the tool as manufactured in accordance with the present disclosure;

FIG. 3 is an illustration of the tool of FIG. 2 in use on a transparent ruler;

FIG. 4 is an illustration of the tool of FIG. 2 employed at two locations on a transparent ruler; and

FIG. 5 illustrates a variety of planform tool shapes that can be employed in accordance with the present disclosure.

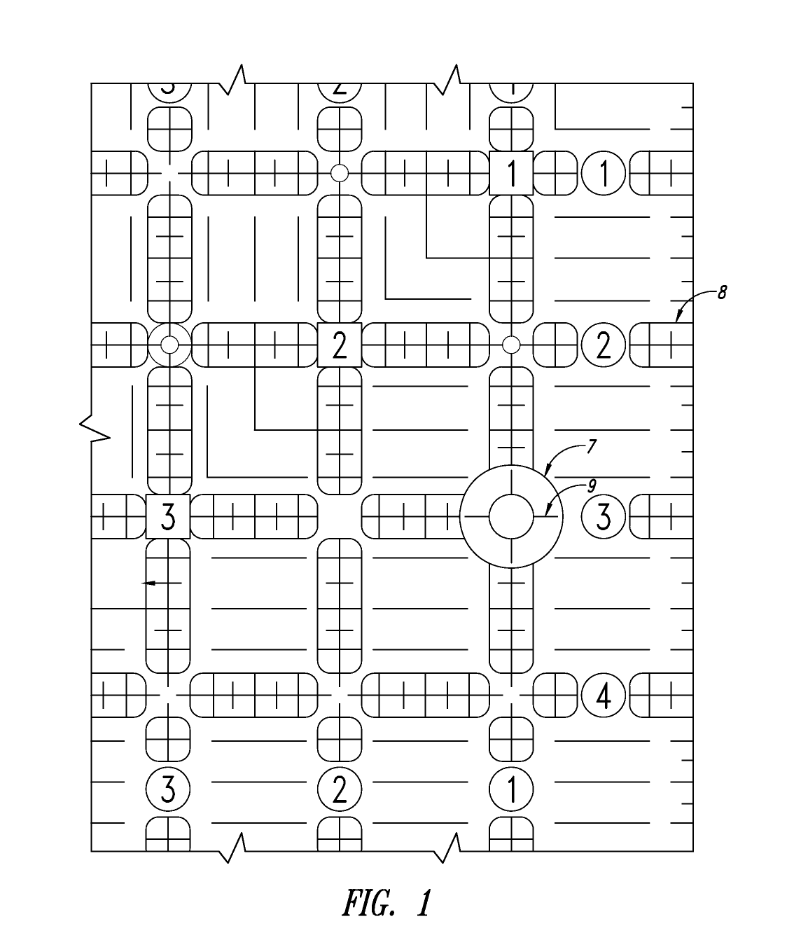

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with the transparent quilting and sewing rulers, tools for marking, and the tools for cutting fabric have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Referring initially to FIG. 2, shown therein is a representative embodiment of a tool 10 formed in accordance with the present disclosure. The illustration in FIG. 2 is of a PVC sheet 20 having a plurality of tools 10 thereon. Preferably, each tool 10 has a diamond-shaped body 12 with opposing flat or planar surfaces, a window 14 in the body 12 that enables viewing through the opposing surfaces of the body 12, and at least one physical feature formed in the body to aid in positioning the tool on the ruler in alignment with one or more lines or other alignment points on the ruler. In this representative example, the tool 10 has a plurality of vertices 16 in the outer perimeter 18 of the body 12 that are oriented to face outward away from the window 14.

The physical feature is not indicia, such as printed or hand drawn lines, but instead is an extension, a cut-out portion, or vertice in the perimeter of the tool 10. The cut-out version of the physical feature could be a triangular planform shape with one vertice extending into the body 12 of material, such as shown in the upper right hand corner of FIG. 5. The line bisecting the triangular shaped cut-out would intersect the center point of the circular opening or window 14 in the body 12.

The opening 14 may have other shapes as described herein, although the shape should facilitate visual alignment by a user with a desired location on the underlying ruler or template and hence the material to be cut or marked. Thus a diamond shape would provide sufficient visual reference for the user's eye to align with the lines on the ruler because the vertices are easily discerned and, in the case of a similarly shaped body, would be aligned with corresponding vertices on the perimeter of the body 12.

The diamond markers 10 are preferably die cut from the PVC sheet 20 as shown in FIG. 2. The shape is a 60 degree diamond that is formed to have a ½″ side-to-side dimension with a ¼″ diameter circular-shaped window 14 formed in the center of the body 12. The thickness of the vinyl sheet 20 could vary from 6 mil to 40 mil. Ideally, each sheet 20 has a 20 mil thickness, although it can range up to and including a 30 mil thickness. Thicknesses less than 6 mil would be difficult to peel off of the ruler. Thicknesses greater than 40 mil would be less likely to adhere to the surface of the ruler because this size of diamond would not have enough surface area to create sufficient adhesion for the weight of the marker. In the manufacture of the tool 12 as shown, the vinyl sheet 20 is die cut so that six tools 10 are attached by bridges created from nicks in the cutting blades used to cut the sheet. In this way the individual tools 10 can be easily separated from the sheet 20 by breaking the small bridge or bridges that holds the tool 10 to adjacent tools 10.

While the body 12 of the tool 10 can be transparent, this would make it difficult to easily see the body 12 on the transparent ruler. For that reason, the body 12 is tinted so it is translucent. Three different tint colors are preferably included in a package of six tools to allow for contrast depending on the colors of fabric being worked with at the time.

Also, the material of the body 12 should have properties that adhere the body 12 to the plastic ruler without requiring adhesive and allow the body 12 to be easily peeled off the ruler. One type of suitable material is plastic or vinyl having static cling properties. While adhesive may be used on a back side of the tool 10, this is not preferred because of the additional cost and complexity in manufacturing and the undesirable properties that adhesives have, including without limitation attracting dust, lint, and threads, and leaving a residue on the ruler surface.

In the representative embodiment of the tool 10 illustrated and described herein, the window 14 is an opening cut through the body 12 that is sized and shaped to provide a line of sight through the body 12 to the ruler and through the ruler to the underlying material. However, the window may also be a transparent portion of the body 12 that is not tinted and is not removed.

As shown in FIGS. 2 through 4, the body 12 has the planform shape of a diamond with a longitudinal axis and a transverse axis, the longitudinal axis bisecting opposing first and second vertices 16 and the transverse axis bisecting opposing third and fourth vertices 16. Each of the first and second vertices 16 has an interior angle of 60 degrees and each of the third and fourth vertices 16 has an interior angle of 120 degrees. In this version of the tool, the window 14 has a circular shape with a center point positioned coincident with the intersection of the longitudinal and transverse axes of the diamond-shaped body 12.

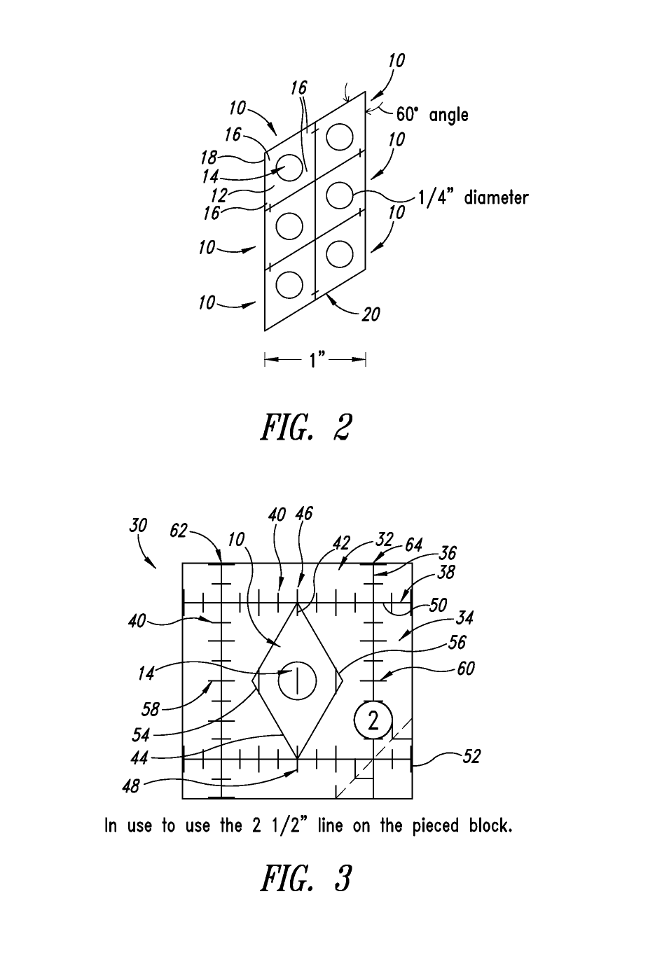

As shown in FIG. 3, a system 30 for use in the sewing and quilting of material is provided. The system includes a transparent measuring device or ruler 32 having a plurality of lines, and the tool 10 described above for use in aligning the transparent measuring device or ruler 32 with underlying material 34. The ruler 32 has vertical lines 36 and intersecting horizontal lines 38 for use in measuring, aligning, cutting, and sewing or quilting the material 34. Each of the vertical and horizontal lines 36, 38 includes graduations 40 at spaced intervals corresponding to the desired measurement system, such as Metric or English units.

In FIG. 3 a single tool 10 formed in accordance with the present disclosure is placed on the ruler 32 surface with the longitudinal axis oriented vertically so that the top and bottom vertices 42, 44 are touching or pointing to the corresponding vertical graduations 46, 48 in the horizontal lines 50, 52. Similarly, the left and right vertices 54, 56, touch or point to the respective horizontal graduations 58, 60 in the respective vertical lines 62, 64. The vertical line 46 can be seen to pass through the center of the opening or window 14. In addition, the underlying material 34 can be seen through the window 14 and the ruler 32.

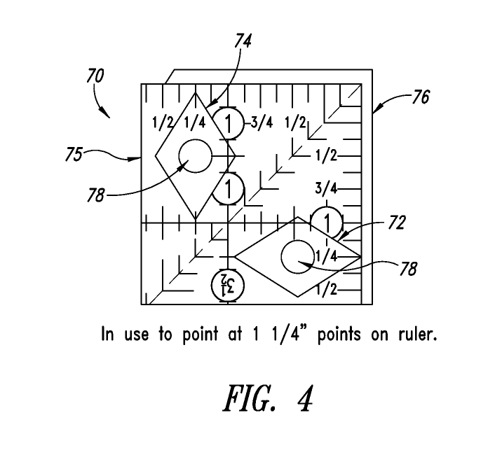

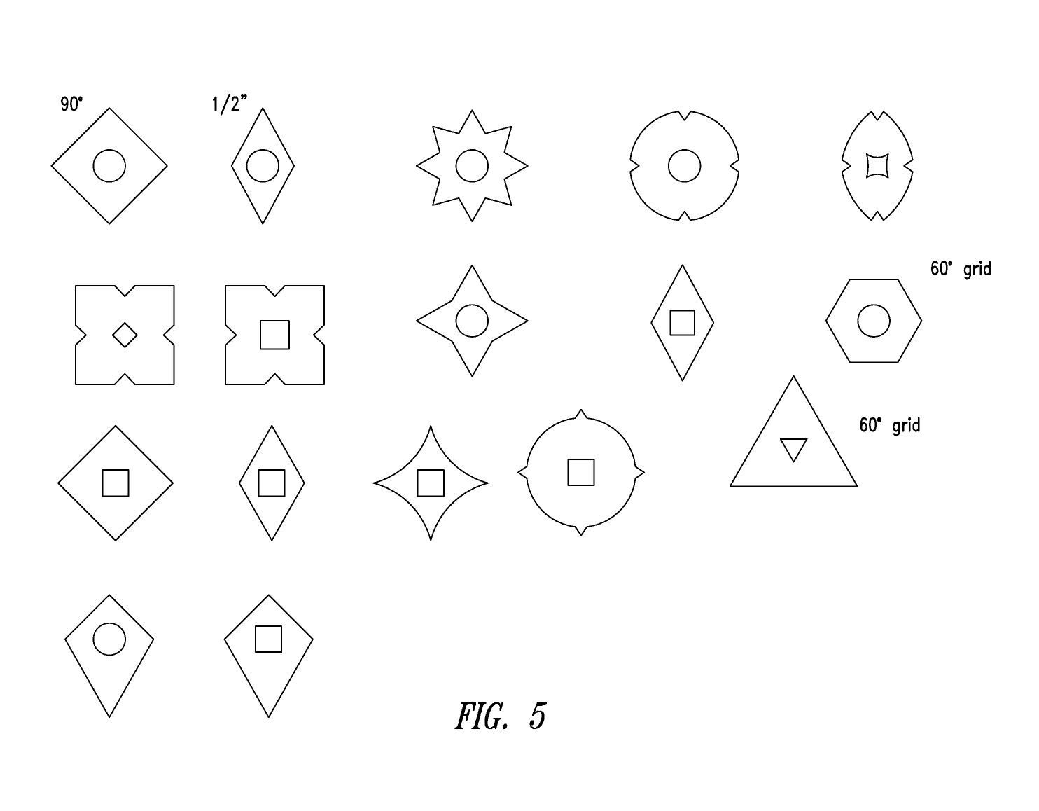

FIG. 4 shows a system 70 that includes a pair of markers 72, 74 used in conjunction with each other and a ruler 75, the markers 72, 74 configured to aid in aligning the ruler 75 with underlying material 76. Each marker 72, 74 is constructed in accordance with the description above for the tool 10. These 60 degree diamond vinyl markers 72, 74 allow the user to mark a point for a particular measurement or position on the ruler 75 and easily see that the ruler 75 is aligned correctly with the material 76. These can be used on long-arm quilting tools and on any slick surface to mark a point. The 60 degree angle vertices are used as this type of pointer. The center circle or window 78 in each marker 72, 74 and the four corners or vertices of the marker 72, 74 create a site with cross-hairs visualized in the windows 78 from the vertices to center a particular point on the ruler with a particular point on the fabric or pieced block. The windows 78 enable the user to see that the desired line or alignment point on the ruler 75 is aligned with the underlying material 76. By having the four corners and the elongated diamond, if needed, a north-south and an east-west orientation can be made.

As mentioned above, masking tape, repositionable note paper, and reinforcement rings are deficient because they cannot provide or perform similar functionality. Such devices are not presented in a form that is diamond in shape and therefore a user would need to cut the device into this type of shape. In the case of the reinforcement ring, the cross hairs have to be printed on the ring, and then the ring does not have the function of pointing to a specific measurement. In addition, these devices are opaque and obscure the surrounding area. Moreover, none of these devices provide for the physical features that facilitate visually finding the location on the ruler for sighting through to the underlying material.

Although prior devices use indicia to help orient them to the lines on the ruler, the present disclosed device avoids the use of printed indicia. To simplify manufacturing and use, the tool 10 uses the physical features manufactured into the body 12, in this case the vertices 42, 44, 54, 56 on the tool 10 described above. It is to be appreciated that other physical features may be used, such as a cutout in the perimeter of the body (shown in the device in the upper right hand corner of FIG. 5. Reference is made to FIG. 5 in which a plurality of different planform shapes for the body may be used. Also seen are different geometric shapes for the window as well as different physical features that may be employed, including cut-outs, multiple vertices, a stretched diamond, a square with both vertices and cut-outs, and combinations of the foregoing.

The tool or marker of the present disclosure is easily applied to the ruler, can be easily repositioned, does not leave residue, is transparent to not obscure the surrounding area, and gives three different methods to marking or identifying visually a point on the ruler.

The various aspects of the present disclosure described above can be combined to provide further embodiments. In addition, various features of the present disclosure can be modified, if necessary or desired, to provide yet further embodiments.

These and other changes can be made in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A tool for use in aligning a transparent measuring device having a plurality of lines with underlying material, the tool comprising:
a body;
a window formed in the body that provides a view through the body to the tool and through the tool to the underlying material; and
at least one physical feature formed in the body that is configured to facilitate longitudinal orientation of the body with a first line on the transparent measuring device and transverse orientation of the tool with a second line on the transparent measuring device.

2. The tool of claim 1, wherein the body comprises flexible material having static cling properties for removably adhering the body to the transparent measuring device.

3. The tool of claim 1, wherein the window comprises one of either a transparent portion of the body or an opening formed through the body that is sized and shaped to provide a line of sight through the body to the transparent measuring device and through the transparent measuring device to the underlying material.

4. The tool of claim 1, wherein the physical feature comprises at least one from among a vertex or a cutout in a perimeter of the body.

5. The tool of claim 1, where the body has a planform shape of a diamond with a longitudinal axis and a transverse axis, the longitudinal axis bisecting opposing first and second vertices and the transverse axis bisecting opposing third and fourth vertices.

6. The tool of claim 5, wherein each of the first and second vertices has an interior angle of 60 degrees and each of the third and fourth vertices has an interior angle of 120 degrees.

7. The tool of claim 6, wherein the window has a circular shape with a center point positioned over the intersection of the longitudinal and transverse axes of the diamond-shaped body.

8. A system for use in sewing and quilting material, the system comprising:
a transparent measuring device having a plurality of lines; and
a tool for use in aligning the transparent measuring device with the material, the tool comprising:
a body;
a window formed in the body that provides a view through the body to the transparent measuring device and through the transparent measuring device to the underlying material; and
at least one physical feature formed in the body that is configured to facilitate longitudinal orientation of the body with a first line on the transparent measuring device and transverse orientation of the tool with a second line on the transparent measuring device.

9. The tool of claim 8, wherein the body comprises flexible material having static cling properties for removably adhering the body to the transparent measuring device.

10. The tool of claim 8, wherein the window comprises one of either a transparent portion of the body or an opening formed through the body that is sized and shaped to provide a line of sight through the body to the tool and through the tool to the underlying material.

11. The tool of claim 8, wherein the physical feature comprises at least one from among a vertex or a cutout in a perimeter of the body.

12. The tool of claim 8, where the body has a planform shape of a diamond with a longitudinal axis and a transverse axis, the longitudinal axis bisecting opposing first and second vertices and the transverse axis bisecting opposing third and fourth vertices.

13. The tool of claim 12, wherein each of the first and second vertices has an interior angle of 60 degrees and each of the third and fourth vertices has an interior angle of 120 degrees.

14. The tool of claim 13, wherein the window has a circular shape with a center point positioned over the intersection of the longitudinal and transverse axes of the diamond-shaped body.
